(19) United States
(12) Patent Application Publication
(10) Pub. No.: US 2010/0126974 A1
(43) Pub. Date: May 27, 2010

(54) METHOD OF PRODUCING DRIP IRRIGATION TUBES

(75) Inventor: Eberhad KERTSCHER, Yvonand (CH)

Correspondence Address: Dorsey & Whitney LLP;Intellectual Property Department - SF, Columbia Center, 701 Fifth Avenue, Suite 6100, Seattle, WA, 98101-7043, US

(73) Assignee: The Thomas Machines S.A., Couvet (CH)

(21) Appl. No.: 12/620,515

(22) Filed: Nov. 17, 2009

(30) Foreign Application Priority Data
Nov. 25, 2008 (EP) EP 08169896.1

(51) Int. Cl. B23K 26/00

(52) U.S. Cl. 219/121.71

(57) ABSTRACT

In a method for producing drip irrigation tubes, a tube body is extruded, in which tube body dosing elements are inserted and are connected to the inner surface of the tube body. In the region of the dosing elements, outlet apertures are made in each case in the tube body using a laser boring device with a specified radiation intensity, through which apertures the water can escape in drops. The radiation intensity of the laser boring device is reduced between procedures. Via a laser optical system co-operating with the laser boring device, the laser beam is led in a controlled way over the surface of the drip irrigation tube, and alphanumerical symbols are burned into this surface. Production of drip irrigation tubes and their labeling can thus be carried out in one operation.

This invention relates to a method of producing drip irrigation tubes, in which method a tube body is extruded, into which dosing elements are inserted and are connected to the inner surface of the tube body, in which tube body outlet apertures are made, in each case in the region of the dosing elements, using a laser boring device with a specified radiation intensity, through which outlet apertures the water conducted into the tube body can escape dropwise.

Methods of this kind for producing drip irrigation tubes are known in diverse ways. Following the step of extrusion of the tube body and the insertion of the dosing elements into this tube body, whereby the dosing elements are connected to the tube body, the tube body is led past a device with which outlet apertures are put in the tube body, which outlet apertures must be positioned precisely with respect to the dosing elements. Various methods are possible for providing outlet apertures of this kind; these outlet apertures can be provided, for example, through a mechanical boring device, through a rotating cutting blade, in particular when the outlet apertures consist of slit-shaped cuts, or by means of laser. Suitable here in particular are Nd/YAG lasers or CO₂ lasers.

These laser boring devices are provided with an optical device, by means of which the laser beam is controlled in a known way and/or can be brought into the desired shape (for instance annular or U-shaped). The laser beam used to make the outlet apertures must have a specified radiation intensity, so that when cutting through the tube body the dosing element placed underneath in each case is not damaged in such a way that a leak occurs on this dosing element. In a known way, the radiation intensity depends on the thickness of the tube walling to be cut, the material of this tube walling and, if need be, on the speed at which the laser beam is led over this tube walling for the latter's cutting through.

Drip irrigation tubes produced in such a way can also be labeled on the surface. For example, a type designation that can comprise various details can be indicated on the surface. The manufacturer can also be mentioned, etc. For putting on labels of this kind, the manufactured tube undergoes a further processing step in which the label is printed, stamped or put on in another way. This additional processing step is time-consuming, and calls for an additional labeling facility, which is considered a drawback.

The object of the present invention thus consists in creating a method for production and labeling of drip irrigation tubes of this kind which is as simple as possible and which requires no additional devices.

This object is achieved according to the invention in that the radiation intensity of the laser boring device is reduced between the boring procedures, in that, via a laser optical system co-operating with the laser boring device, the laser beam is led in a controlled way over the surface of the drip irrigation tube, and alphanumerical symbols are burned into this surface.

Through this method the laser boring device already present in the configuration for production of drip irrigation tubes can also be used for putting on the labeling, which greatly simplifies the manufacture of the drip irrigation tubes including labeling, whereby time and costs can be saved.

In an advantageous way, the tube body with the dosing elements inserted therein is led past the laser boring device continuously. During the operation, via the laser optical system, the laser beam is guided in a way following the tube body movement.

In the region of laser processing, the tube body is supported on a support roller, and wraps around the latter at least partially. Achieved thereby is that the tube body is precisely guided in this region, the at least partial wrapping of the support roller by the tube body furthermore prevents a change in length of the tube body through possibly arising different tensile stresses during moving away of the tube body.

For precisely positioned making of each outlet aperture in the tube body, the position of the dosing elements is preferably determined via sensor means. This enables the outlet aperture to be made correctly in the tube body, even when the dosing elements are spaced apart differently from one another, for example.

Based on this determined position for each of the outlet apertures to be made in the tube body, it is also possible to determine the position for the alphanumerical symbols to be applied, whereby it is ensured that the boring procedure and that of application of the alphanumerical symbols are not able to interfere with one another.

The positioning of the tube body with respect to the laser boring device is preferably adjusted transversely to the longitudinal direction of the tube body through adjustment of guide rollers disposed in front of and behind the support roller, it being thereby possible for this positioning to be carried out in a very simple way.

The spacing between the laser boring device and the tube body to be processed is preferably adjusted by lifting or respectively lowering the support roller; this can also be carried out very easily.

The method according to the invention for producing drip irrigation tubes will be described more closely in the following, by way of example, with reference to the attached drawings.

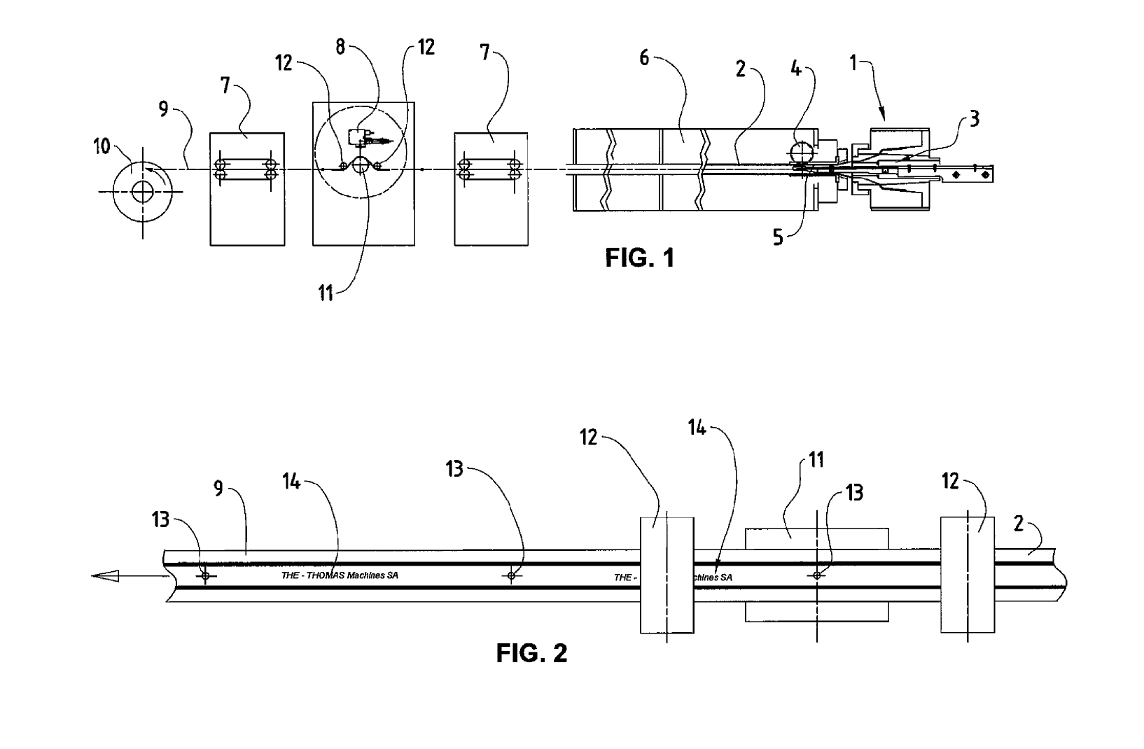

FIG. 1 shows in a diagrammatical representation a view of a facility for production of drip irrigation tubes;

FIG. 2 is a view from above of the tube in the region of the support roller, with outlet apertures and labeling provided;

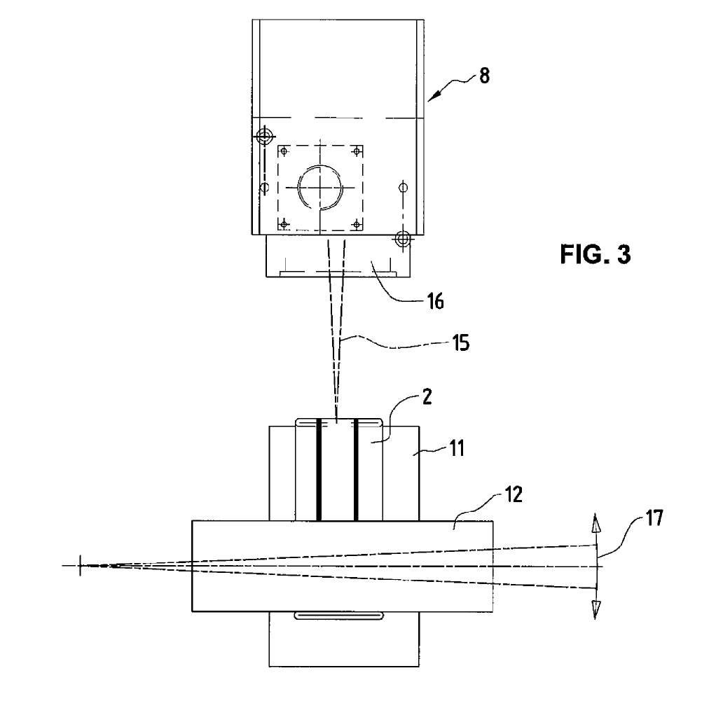

FIG. 3 is a view from the front of the support and guide rollers, with inserted drip irrigation tube; and

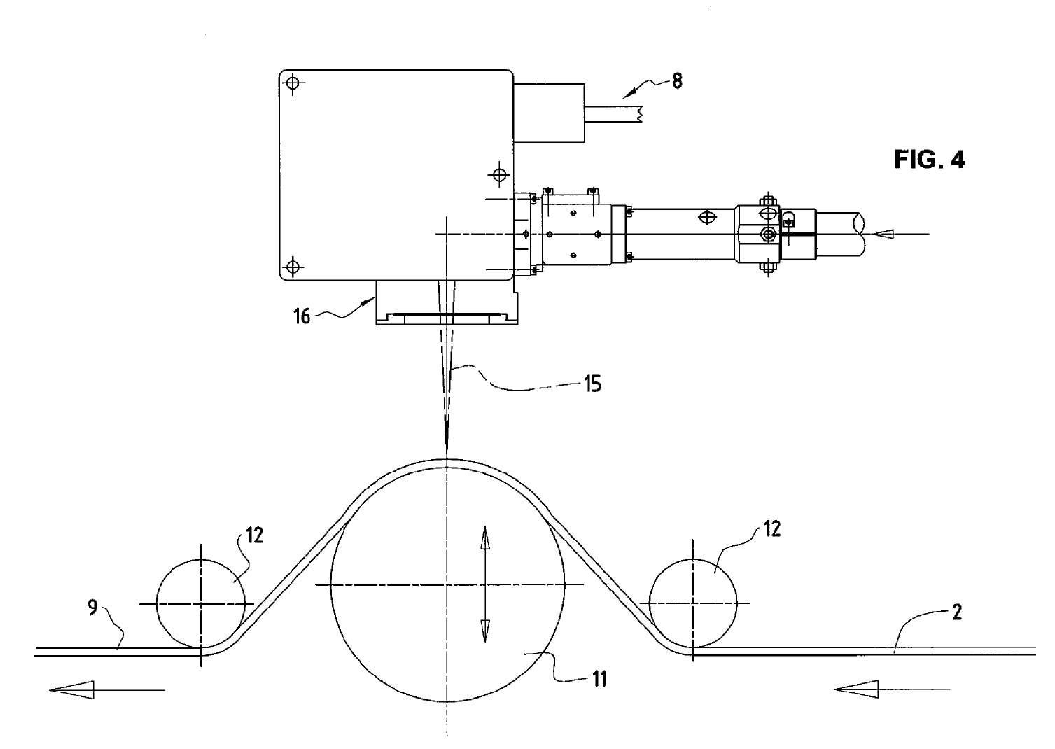

FIG. 4 is a view of the support roller and the guide rollers with the laser boring device.

FIG. 1 shows in a diagrammatic representation a configuration for producing drip irrigation tubes. In an extrusion device 1, a tube body 2 is continuously extruded. In this tube body 2, dosing elements are inserted into the tube body 2 via a feed device 3 in a known way and are connected to this tube body. Serving to press these dosing elements in the tube body 2 is a pressing roller 4, which is in contact with the tube body 2 on the outside. Via a guiding rail 5, the fed dosing elements are pressed on the inside of the tube body 2 against the still soft tube body, and are connected thereto.

The tube body 2, provided with the dosing elements, is then led through cooling devices 6; the tube body 2 hardens by means of the cooling step. Via advancing devices 7, the tube body 2 is led through the laser boring device 8, with which the outlet apertures are made in the tube body 2 in the correct position with respect to the dosing elements, and with which the tube body can be labeled, for example, as will still be described later in detail. The thus produced drip irrigation tube 9 can be subsequently wound on a winding device 10. The respective wound rolls can then be delivered to the users.

As can be learned from FIG. 1 and FIG. 2, the tube body 2 is guided in the region of the laser boring device via a support roller 11. Disposed in front of and behind this support roller 11 is one guide roller 12 each in such a way that the tube body 2 wraps around the support roller 11 over a portion of its circumference. In the middle portion of the wrapping region, the outlet apertures 13 are made in the tube body 2 by the laser boring device 8. The alphanumerical symbols 14 seen in FIG. 2 are likewise provided on the tube body 2 in this region by the laser boring device 8, as will still be described in detail later.

As can be seen from FIG. 3, a laser beam 15 is generated in the laser boring device 8 in a known way, which laser beam is directed onto the surface of the tube body 2 via a laser optical system 16, which tube body 2 is supported on the guide roller 12 and wraps partially around this roller. The laser optical system 16 is, on the one hand, designed in such a way that the laser beam 15 is focused in a known way on the point of incidence on the tube body 2, so that the greatest irradiance is achieved at this point, whereby an optimal cutting or boring operation is obtained. In a known way, the position of each dosing element inside the tube body is determined via a sensor device (not shown). Via control means (not shown), the laser boring device is activated at the right point in time so that the outlet aperture 13 can be made in the correct position in the tube body 2. This outlet aperture can have difference shapes. It can be a circular hole, as is shown in FIG. 2. This outlet aperture could also be designed only as a cut of a particular length, however. One could also design the outlet aperture as two intersecting cuts, depending upon the type of application and the wall thickness of the tube body. The laser beam 15 is also correspondingly guided via the laser optical system 16 in a known way.

As can be seen from FIG. 3, the tube body 2 to be processed by the laser boring device 8 can be positioned laterally on the support roller 11, which is achieved in that the guide rollers 12 are able to be adjusted in their angular position, represented by arrow 17. Depending upon the angular position of the guide rollers 12, the path of the tube body 2 can be positioned laterally with respect to the laser boring device 8, via the support roller 11.

Seen in FIG. 4 is the laser boring device 8. The tube body 2 runs over the support roller 11, guided by the two guide rollers 12, so that the tube body 2 clasps the support roller 11 around a particular region. In order to be able to adjust the spacing of the tube body 2 with respect to the laser boring device 8, the support roller 11 is borne in an adjustable way, so that it can be moved toward the laser boring device 8 or respectively away from the latter, and is lockable in the desired position. In that the tube body 2 clasps the support roller 11 around a particular region, it is supported in an optimal way. A change in length of the tube body in this region is thereby prevented; the operations can be carried out with precision by the laser boring device.

For making the outlet apertures 13 (FIG. 2) in the tube body 2, work is carried out with a predefined radiation intensity. When an outlet aperture has been made, the radiation intensity of the laser boring device can be reduced in the following task; via the laser optical system and corresponding control means, the laser beam 15 can be subsequently led over the surface of the tube body 2 in a known way, so that alphanumerical symbols 14 can be burnt into this surface of the tube body 2 (FIG. 2). These alphanumerical symbols 14 can contain different information, for instance tube diameter, type of drip irrigation tube, manufacturer, etc. After this, when the next outlet aperture 13 is supposed to be made in the onwardly moving tube body 2, the radiation intensity of the laser beam 15 can be correspondingly increased again, so that the cutting step can be carried out.

Since the position of the dosing elements in the tube body 2 can be precisely determined via the sensor means, and hence also precisely determined is where the corresponding outlet apertures 13 are to be made in the tube body, the alphanumerical symbols that are burned into the surface of the tube body can also be positioned correspondingly between the outlet apertures in a known way.

With this configuration of the invention, a method is obtained by means of which, using a facility for production of these drip irrigation tubes, labeling of drip irrigation tubes can be carried out simultaneously, without additional time, effort and/or outlay. The production of the drip irrigation tubes and the labeling of these tubes take place during one and the same operation. No further additional devices are needed. The method can therefore be applied very simply and very economically.

1. A method of producing drip irrigation tubes, in which method a tube body is extruded, in which body dosing elements are inserted and are connected to the inner surface of the tube body, in which tube body outlet apertures are made in each case in the vicinity of the dosing elements using a laser boring device with a specified radiation intensity, through which apertures the water guided in the tube body is able to escape dropwise, wherein the radiation intensity of the laser boring device is reduced between the boring procedures, in that, via a laser optical system co-operating with the laser boring device, the laser beam is led in a controlled way over the surface of the drip irrigation tube, and alphanumerical symbols are burned into this surface.

2. The method according to claim 1, wherein the tube body with the dosing elements inserted therein is led past the laser boring device in a continuous way.

3. The method according to claim 1 or 2, wherein the tube body is supported on a support roller in the region of the laser processing, and this support roller is wrapped around at least partially by the tube body.

4. The method according to claim 1, wherein, for precisely positioned making of each outlet aperture in the tube body, the position of the dosing elements is determined via sensor means.

5. The method according to claim 4, wherein the position for the alphanumerical symbols to be applied is determined on the basis of the determined position of the respective outlet apertures to be made in the tube body.

6. The method according to claim 3, wherein the positioning of the tube body with respect to the laser boring device is adjusted transversely to the longitudinal direction of the tube body through adjustment of guide rollers disposed in front of and behind the support roller.

7. The method according to claim 3, wherein the spacing between the laser boring device and the tube body to be processed is adjusted by raising or respectively lowering of the support roller.
